(19) United States
(12) Patent Application Publication
(10) Pub. No.: US 2014/0260878 A1
(43) Pub. Date: Sep. 18, 2014

(54) Circular Saw Plate with Thickness Discontinuity

(71) Applicant: California Saw & Knife Works, San Francisco, CA (US)

(72) Inventor: Warren M. Bird, San Francisco, CA (US)

(21) Appl. No.: 13/907,662

(22) Filed: May 31, 2013

Related U.S. Application Data
(60) Provisional application No. 61/784,869, filed on Mar. 14, 2013.

(51) Int. Cl. B23D 61/02

(52) U.S. Cl. CPC B23D 61/025
USPC 83/835

(57) ABSTRACT

A circular saw includes a circular disk-shaped body with an outer periphery having saw teeth separated by gullets and saw tooth tips at the saw teeth. The saw tooth tips have a saw kerf. At least one of the gullets has a radially innermost margin at a first radius. The body has a thickness discontinuity at a second radius, the second radius being at least equal to the first radius. The body has a first thickness adjacent to and radially outside of the thickness discontinuity and a second thickness adjacent to and radially inside of the thickness discontinuity. The second thickness is greater than the first thickness. The ratio of the difference between the second thickness and the first thickness, and the difference between the kerf and the first thickness is equal to or greater than 0.25.

### CROSS-REFERENCE TO OTHER APPLICATIONS

This application claims the benefit of U.S. provisional patent application No. 61/784,869, filed 14 Mar. 2013, and entitled Circular Saw Plate with Thickness Discontinuity.

### FEDERALLY SPONSORED RESEARCH OR DEVELOPMENT

None.

### BACKGROUND

Circular saws are used to manufacture products from wood and other materials. Optimal utilization of the raw material—realizing its maximum intrinsic value—and the efficiency of the associated manufacturing system are dependent upon the tools used in the sawing process. To achieve the desired recovery and production goals, the accuracy and reliability with which the saw cuts and the size of the saw kerf are key factors.

### SUMMARY

A circular saw includes a circular disk-shaped body and saw tooth tips. The body has a center at an axis of rotation, first and second faces oriented in opposite axial directions, and an outer periphery. The outer periphery has saw teeth separated by gullets. The saw tooth tips are at the saw teeth. The saw tooth tips have a saw kerf measured parallel to the axis of rotation. At least one of the gullets has a radially innermost margin at a first radius from the center of the body. The body has a thickness discontinuity, as measured between the first and second faces, at a second radius, the second radius being at least equal to the first radius. The body has a first thickness between the first and second faces at a first location adjacent to and radially outside of the thickness discontinuity. The body also has a second thickness between the first and second faces at a second location adjacent to and radially inside of the thickness discontinuity. The second thickness is greater than the first thickness. A distance X is equal to the difference between the second thickness and the first thickness, and a distance Y is equal to the difference between the kerf and the first thickness. The ratio of X to Y is equal to or greater than 0.25. Some examples may include one or more the following. The ratio of X to Y may be equal to or greater than 0.3. The second thickness may be at least 10% greater than the first thickness. The thickness discontinuity may have a radial dimension of about 0.8 mm-1.6 mm.

Other features, aspects and advantages of the present invention can be seen on review of the drawings, the detailed description, and the claims which follow.

### BRIEF DESCRIPTION OF THE DRAWINGS

FIG. 1 is a side view of a circular saw including a saw plate, having a series of teeth separated by gullets along its periphery, and saw tooth tips at the outer ends of the teeth.

FIG. 2 is an enlarged view of a tooth and saw tooth tip of the saw blade of FIG. 1.

FIG. 3 is a top plan view of a portion of an example of a tooth and saw tooth tip of FIG. 2, taken along line B-B, illustrating the saw kerf and a tangential clearance angle.

FIG. 4 is a top plan view of a portion of an example of a tooth and saw tooth tip of FIG. 2, taken along line B-B, illustrating a face bevel angle.

FIG. 5 is a side elevation view of a portion of an example of a tooth and saw tooth tip of FIG. 2, taken along line A-A, illustrating a top bevel angle.

FIG. 6 is a side elevation view of a portion of an example of a tooth and saw tooth tip of FIG. 2, taken along line A-A, illustrating a radial clearance angle.

FIG. 7 is an enlarged view of two adjacent teeth and saw tooth tips of the saw blade of FIG. 1.

FIG. 8 is an enlarged side elevation view of a tooth and saw tooth tip of FIG. 7 identifying various dimensions.

### DETAILED DESCRIPTION

The following description will typically be with reference to specific structural embodiments and methods. It is to be understood that there is no intention to limit the invention to the specifically disclosed embodiments and methods but that the invention may be practiced using other features, elements, methods and embodiments. Preferred embodiments are described to illustrate the present invention, not to limit its scope, which is defined by the claims. Those of ordinary skill in the art will recognize a variety of equivalent variations on the description that follows. Like elements in various embodiments are commonly referred to with like reference numerals.

Referring now to FIGS. 1 and 2, a circular saw 10 includes a saw plate 12 in the form of a circular disk. Saw plate 12 has a center 11 defining an axis of rotation, with teeth 14 arrayed about its outer periphery 15. Circular saw 10 also includes saw tooth tips 16 at the outer ends of the teeth 14. The teeth 14 are separated by spaces or gullets 18 which serve to capture the chips or sawdust generated by the cutting process. The saw tooth tips 16, which are attached to or integral with the teeth 14, perform the cutting. The saw tooth tips 16 are commonly made from a more wear-resistant material than the saw plate 12 and are characterized by size and geometry: the width of the saw tooth tip 16, commonly referred to as the saw kerf 20, see FIG. 3; its length 22; its thickness 24; its rake (or hook) angle 26 measured from a radial line 27 extending from the center 11; the top clearance angle 28; the face bevel angle 30, see FIG. 4, and/or top bevel 32, see FIG. 5; and the radial clearance angle 34, see FIG. 6, and tangential clearance angle 36, see FIG. 3. In order to avoid friction between the workpiece and the saw plate 12, the saw kerf 20 is greater than the saw plate thickness. The radial and tangential clearance angles 34 and 36 reduce friction between the workpiece and the sides of the tooth tip.

As a consequence of the presence of the radial and tangential clearance angles 34 and 36, re-sharpening the saw tooth tips 16 (by grinding the face and/or top surfaces) results in reduction of the saw kerf 20, and, hence, of the amount of clearance between the saw kerf 20 and the teeth 14 of the saw plate 12. It is therefore desirable that the initial difference between the thickness of the saw teeth 14 and the size of the saw kerf 20 be great enough to allow several cycles of operation and re-sharpening before the saw tooth tip 16 must be removed and replaced by a tip of the original dimensions. Note that in some situations saws are not re-tipped but are discarded after being re-sharpened a number of times. The above-described structure and characteristics are generally conventional.

Referring now to FIGS. 1, 6 and 7, circular saw plate 12 includes a thicker interior zone 38 and a thinner outer zone 40 joined by a thickness discontinuity 42. The thicker interior zone 40 extends radially to the base of the gullet 18, indicated by dashed lines 44 in FIG. 7, or beyond the base of the gullet 18 of the saw plate 12, as in the example of FIGS. 1, 6 and 7. For a given saw kerf 20, circular saw 10 achieves and maintains greater cutting accuracy during the cutting process, while allowing the saw tooth tip 16 to be re-sharpened in a normal manner.

FIG. 8 is an enlarged view of the tooth profile of a tipped saw. The wider portion at the edge is the saw tooth tip 16, which is typically applied after manufacture of the saw plate 12. The thinner outer zone 40 includes teeth 14. The transition at the radial margin between the thicker interior zone 38 and the thinner outer zone 40 is a step transition creating the thickness discontinuity 42 at the radial margin. The thickness discontinuity 42 is located at the radial innermost margin of the saw tooth gullet profile, indicated by a dashed line 44 in FIG. 7, or at some position radially outwardly thereof, for example at the solid line thickness discontinuity 42 shown in FIGS. 1, 7 and 8. Interior zone 38 has a thickness 48 adjacent to and on one side of the thickness discontinuity 42 while outer zone 40 has a thickness 50 adjacent to and on the other side of discontinuity 42. The radial dimension 46 of the thickness discontinuity 42, that is the radial distance between where the discontinuity starts and the discontinuity stops, is typically about 0.03-0.06 inch (0.8-1.6 mm). The discontinuity can be a circular arc or other curved surface, or a combination of flat and curved surfaces with interior corners curved to reduce stress concentrations. The difference between the thinner and thicker zones of the saw plate 12, identified as B1 and B2 in FIG. 8, is greater than or equal to 25%, and preferably at least 30%, of the difference between the saw kerf 20 and the thinnest portion of the saw plate measured radially outwardly of the step transition, identified as A1 and A2 in FIG. 8. Therefore, the sum of B1 and B2 divided by the sum of A1 and A2, referred to as the thickness ratio, is greater than or equal to 0.25, and preferably at least 0.30. Typically, distance A1 is equal to distance A2 and a distance B1 is equal to distance B2. The thickness 48 at a second location adjacent to but radially inward of the thickness discontinuity 42 is about 10% greater than the thickness 50 at a first location adjacent to but radially outward of the thickness discontinuity 42.

A circular saw similar to that shown in FIGS. 1 and 7, referred to as the prior art saw, was created by the current inventor and was on sale prior to 14 Mar. 2012. The thickness ratio for the prior art saw was 0.186. The prior art saw was designed and manufactured to reduce the rim thickness and saw kerf of a saw plate which was 0.090″ thick, with a kerf of 0.130″, rather than being designed to increase the saw's stiffness. The rim was reduced by 0.008″ to a thickness of 0.082″; the kerf was reduced by only 0.005″ to 0.125″ to provide one additional re-sharpening before replacement of the saw tip. At that time it was believed that it would not been realistic to increase the reduction in the rim thickness over the 0.008″ reduction because of the perceived danger of frictional heating caused by the workpiece rubbing against the sides of the saw plate, a situation which almost always results in severe damage to the saw. Only recently did the current inventor recognize that the thickness ratio could be substantially increased over the 0.186 thickness ratio of the prior art saw, such as at least 0.25 and more preferably at least 0.30, without danger to the saw. In contrast to existing circular saws, a circular saw made according to the present invention with the thickness ratio of at least 0.25 and preferably at least 0.30 provides a very large increase in the saw's resistance to lateral deflection while cutting, as described below. This increase in the resistance to lateral deflection provides (1) a reduction in loss of value of the sawn product due to size variation in the product which exceeds allowed limits, or (2) increased volumetric yield due to the ability to saw the product to dimensions which are closer to the allowed minimum size.

The saw plate 12 described would typically be used to make a saw 10 by adding tungsten carbide or cobalt-based alloy tips 16 to the teeth 14 or by swaging integral tips 16 to the teeth 14; it would also be leveled and tensioned in a manner appropriate to the material of which the saw plate 12 is made, the material to be cut, and the cutting parameters of the process in which the saw will be used. It would be incorporated into a sawing machine in one of several typical manners and used for cutting a workpiece into two or more pieces.

Various embodiments, some of which are described below, can improve sawing accuracy and sawing process reliability. It is believed it is by:

Increasing resistance to elastic lateral deflection of the saw plate 12 through increasing its potential energy of bending, which is achieved by
a. Increasing the thickness of the saw plate 12, lateral stiffness of a thin plate being proportional to the cube of its thickness,
b. Decreasing the loss of lateral stiffness which is associated with thermally-induced compressive hoop stresses in the plane of the saw plate 12, by adding mass to or adjacent to the saw tooth 14 through which heat from the saw tooth tip 16 must be conducted before reaching the continuous portion of the saw plate and by adding mass to the remainder of the saw plate, thus lowering the temperature gradient between the outer and inner radii of the saw plate.

Increasing resistance to critical speed instability under operating conditions, by the increase in the natural frequencies of vibration associated with FIGS. 7 and 8.

Increasing resistance to plastic deformation of the saw plate 12 by the decrease in bending stress associated with the increase in saw plate thickness.

The various embodiments can also provide the ability to maintain an existing level of sawing accuracy during the cutting process using a smaller saw kerf 20 than would otherwise be required.

### ALTERNATIVE EMBODIMENTS

One alternative embodiment includes saw plates 12 which have parallel major surfaces (which are of uniform thickness) designed to accommodate hydrostatic or hydrodynamic guide pads in a sawing machine which establish the saw location and provide added resistance to saw deflection adjacent to the working zone of the saw plate. The working zone is the radial portion which extends into and through the workpiece. This saw plate 12 may also contain a thicker integral central hub which is outside the cutting zone.

Another alternative embodiment includes circular saw plates 12 which are of uniform thickness but which are centrally clamped in a sawing machine, without saw guides. This saw plate 12 may also contain a thicker integral central hub which is outside the cutting zone.

A further alternative embodiment includes circular saw plates 12 which are centrally clamped in a sawing machine without saw guides, but which are tapered within the zone which passes through the workpiece during the cutting process; in this case, for a given saw kerf 20, the taper of the saw plate 12 can be manufactured at a smaller slope than had previously been used, and at a point which is at or beyond the radially innermost margin of the tooth gullet 18, there is a thickness discontinuity 42 at a stepped transition, at which point the saw plate 12 becomes thinner, but the taper in this thinner part of the saw plate can continue to the outer edge of the saw plate tooth at the same angle as the taper in the thicker central portion of the saw, at a different taper angle, or with no taper angle. This saw plate 12 may also contain a thicker integral central hub which is outside the cutting zone.

The above descriptions may have used terms such as above, below, top, bottom, over, under, et cetera. These terms may be used in the description and claims to aid understanding of the invention and not used in a limiting sense.

While the present invention is disclosed by reference to the preferred embodiments and examples detailed above, it is to be understood that these examples are intended in an illustrative rather than in a limiting sense. It is contemplated that modifications and combinations will occur to those skilled in the art, which modifications and combinations will be within the spirit of the invention and the scope of the following claims.

Any and all patents, patent applications and printed publications referred to above are incorporated by reference.

What is claimed is:

1. A circular saw comprising:
a circular disk-shaped body comprising a center at an axis of rotation, first and second faces oriented in opposite axial directions, and an outer periphery;
the outer periphery having saw teeth separated by gullets;
saw tooth tips at the saw teeth;
the saw tooth tips having a saw kerf measured parallel to the axis of rotation;
at least one of the gullets having a radially innermost margin at a first radius from the center of the body;
the body having a thickness discontinuity, as measured between the first and second faces, at a second radius, the second radius being at least equal to the first radius;
the body having a first thickness between the first and second faces at a first location adjacent to and radially outside of the thickness discontinuity;
the body having a second thickness between the first and second faces at a second location adjacent to and radially inside of the thickness discontinuity;
the second thickness being greater than the first thickness;
a distance X equal to the difference between the second thickness and the first thickness;
a distance Y equal to the difference between the kerf and the first thickness; and
the ratio of X to Y being equal to or greater than 0.25.

2. The circular saw according to claim 1, wherein the ratio of X to Y is equal to or greater than 0.3.

3. The circular saw according to claim 2, wherein the second thickness is at least 10% greater than the first thickness.

4. The circular saw according to claim 1, wherein the second thickness is at least 10% greater than the first thickness.

5. The circular saw according to claim 1, wherein the thickness discontinuity has a radial dimension of about 0.8 mm-1.6 mm.

6. A circular saw comprising:
a circular disk-shaped body comprising a center at an axis of rotation, first and second faces oriented in opposite axial directions, and an outer periphery;
the outer periphery having saw teeth separated by gullets;
saw tooth tips at the saw teeth;
the saw tooth tips having a saw kerf measured parallel to the axis of rotation;
at least one of the gullets having a radially innermost margin at a first radius from the center of the body;
the body having a thickness discontinuity, as measured between the first and second faces, at a second radius, the second radius being at least equal to the first radius;
the thickness discontinuity having a radial dimension of about 0.8 mm-1.6 mm;
the body having a first thickness between the first and second faces at a first location adjacent to and radially outside of the thickness discontinuity;
the body having a second thickness between the first and second faces at a second location adjacent to and radially inside of the thickness discontinuity;
the second thickness is at least 10% greater than the first thickness;
a distance X is equal to the difference between the second thickness and the first thickness;
a distance Y is equal to the difference between the kerf and the first thickness; and
the ratio of X to Y is equal to or greater than 0.25.

7. The circular saw according to claim 6, wherein the ratio of X to Y is equal to or greater than 0.30.
